(19) United States
(12) Patent Application Publication
(10) Pub. No.: US 2008/0042462 A1
(43) Pub. Date: Feb. 21, 2008

(54) Collapsible tubing device for automobile shade

(76) Inventor: Kevin Scotton, Aberdeen, NC (US)

Correspondence Address: TRIANGLE PATENTS, P.L.L.C., P.O. BOX 28539, RALEIGH, NC, 27611-8539, US

(21) Appl. No.: 11/506,568

(22) Filed: Aug. 18, 2006

(51) Int. Cl. B60R 27/00

(52) U.S. Cl. 296/24.4

(57) ABSTRACT

A foldable security screen for use in an automobile is disclosed. The security screen comprises a flexible screen and at least one foldable tubing device. The foldable tubing device further comprises at least one bar that is flexibly attached to at least one other bar. The foldable tubing device is also attached to the screen. The bars of the foldable tubing device can be connected to each other to make the tubing device and the security screen rigid, when desired. The bars can be disconnected to make the screen foldable for easy removal and storage.

### BACKGROUND OF THE INVENTION

1. Field of the Invention

The current invention relates to the field of security screens in the rear cargo area of automobiles and more particularly to foldable screens in the cargo section of automobiles.

2. Description of the Prior Art

Automobiles such as Sport Utility Vehicles (SUVs), wagons and hatchbacks have a rear cargo screen. The rear cargo screen is made of a hard material. The purpose of the screen is to maintain the privacy of the cargo under the screen and in certain cases to protect the cargo from direct sunlight.

When large cargo has to be stored, the screen has to be removed. This is usually cumbersome because of the size of the screen. It is also difficult to temporarily store the screen in the vehicle because of the same reason.

There are several U.S. patents that address this issue. One such patent is U.S. Pat. No. 6,702,355, titled “Multi-function security shade panel for a vehicle” assigned to General Motors Corp., which claims a security shade apparatus. This apparatus is retractable and is mounted with the help of a hinge to the back side of the rear seats in an automobile. A support member is required to support the panel in an extended position and to enable it to work as a security screen.

U.S. patent application Ser. No. 11/069,215 titled “Automotive Cargo Restraint and Security Screen” claims a retractable security screen that is operable in multiple positions. It can be used vertically to screen off the rear cargo area from the front passenger area in addition to the conventional use as a cargo screening device in the horizontal position. The screen retracts into spring loaded housing when it is not needed. The security screen requires attachment supports to be fixed at predetermined positions along the side walls of the cargo area. The attachment supports lock an attachment handle that is placed at the free end of the screen.

It is evident from the above discussion that there is a need for a screen that is light weight, easily removable or storable but also can be used in an automobile without changes to the rear seat or addition of other mechanical members in the cargo area.

### SUMMARY OF THE INVENTION

It is therefore an object of the present invention to provide a foldable cargo security screen for an automobile, the foldable security having a screen, at least one foldable tubing device such that the tubing device further has at least one bar that is flexibly attached to at least one other bar and the tubing device is attached to the screen.

It is an additional object of the present invention to provide a foldable cargo security screen for an automobile, the foldable security having a screen, at least one foldable tubing device such that the tubing device further has at least one bar that is flexibly attached to at least one other bar by means of an elastic material and the tubing device is attached to the screen.

It is another object to provide a foldable cargo security screen for an automobile, the foldable security having a screen, at least one foldable tubing device such that the tubing device further has at least one bar that is flexibly attached to at least one other bar and the tubing device is attached to the screen, such that the foldable cargo security screen is held in a substantially horizontal position in the automobile cargo area by releasably attaching to one or more recessed in the automobile cargo area.

### BRIEF DESCRIPTION OF DRAWINGS

FIG. 1 is an illustration of a foldable automobile cargo security screen, in accordance with an embodiment of the present invention.

FIG. 2 is an illustration of a foldable tubing device, in accordance with an embodiment of the present invention.

FIG. 3 is an illustration of a foldable tubing device, in accordance with an embodiment of the present invention.

FIG. 4 is an illustration of a foldable tubing device, in accordance with an embodiment of the present invention.

FIG. 5 is an illustration of a foldable tubing device in a rigid position, in accordance with an embodiment of the present invention.

FIG. 6 is an illustration of a foldable automobile cargo security screen, in accordance with an embodiment of the present invention.

### DETAILED DESCRIPTION OF THE PREFERRED EMBODIMENTS

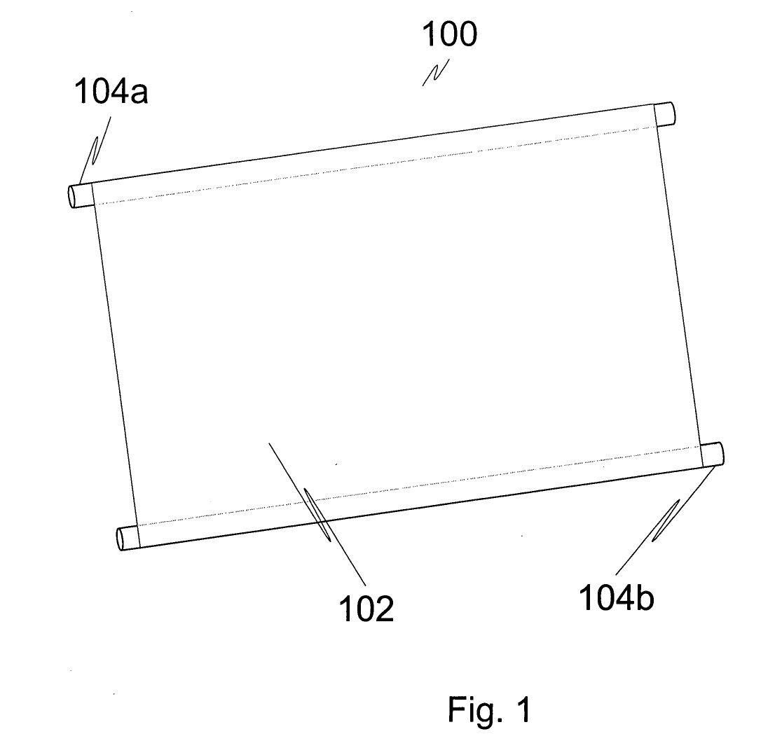

The present invention provides a foldable security screen to be used in automobiles for covering the cargo area of the automobiles. FIG. 1 is an illustration of a foldable automobile cargo security screen, in accordance with an embodiment of the present invention. Foldable automobile cargo security screen 100 comprises of a screen 102 and foldable tubing devices 104a and 104b. Screen 102 is made of a material that is flexible or foldable. An exemplary material for screen 102 is cloth.

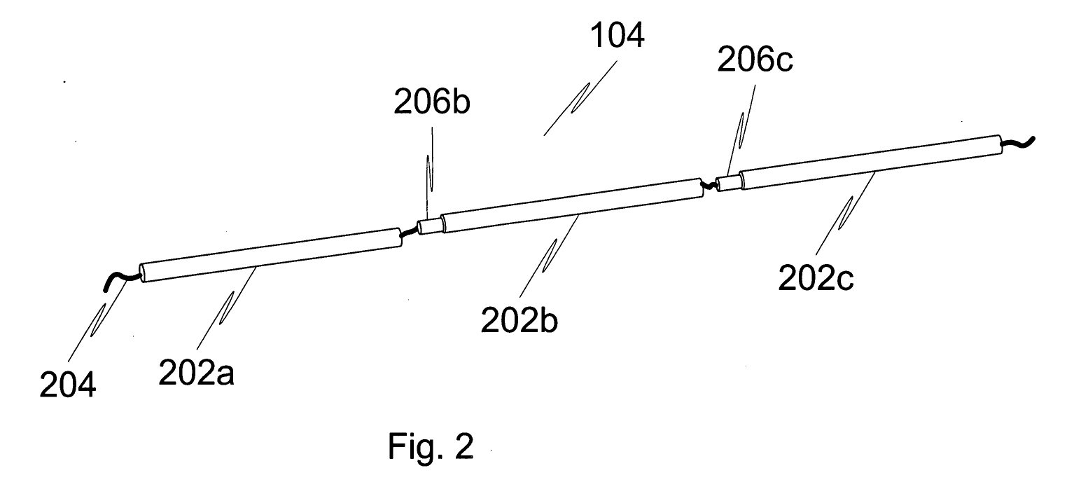

FIG. 2 is an illustration of a foldable tubing device 104, in accordance with an embodiment of the present invention. Tubing device 104 comprises of bars 202. Bars 202a, 202b and 202c are connected together by means of a flexible elastic material 204. In an embodiment of the present invention, elastic material 204 is routed through the center of the bars 202, which are hollow. Bars 202 have a small length 206, at one end that has a diameter that is smaller than the rest of their body. This reduced diameter enables one end of bar 202b to fit inside another end of bar 202a. Elastic material 204 exerts a force on bars 202 so that bar 202c automatically fits into bar 202b and bar 202b fits into bar 202a. Bar 202c fits into bar 202b because length 206c fits inside bar 202b. Similarly, length 206b fits into bar 202a. It will be apparent to one skilled in the art that means other than elastic material 204 for flexibly connecting bars 202 are within the scope of the invention. In another embodiment of the present invention, bars 202 are connected by means of a flexible coupling.

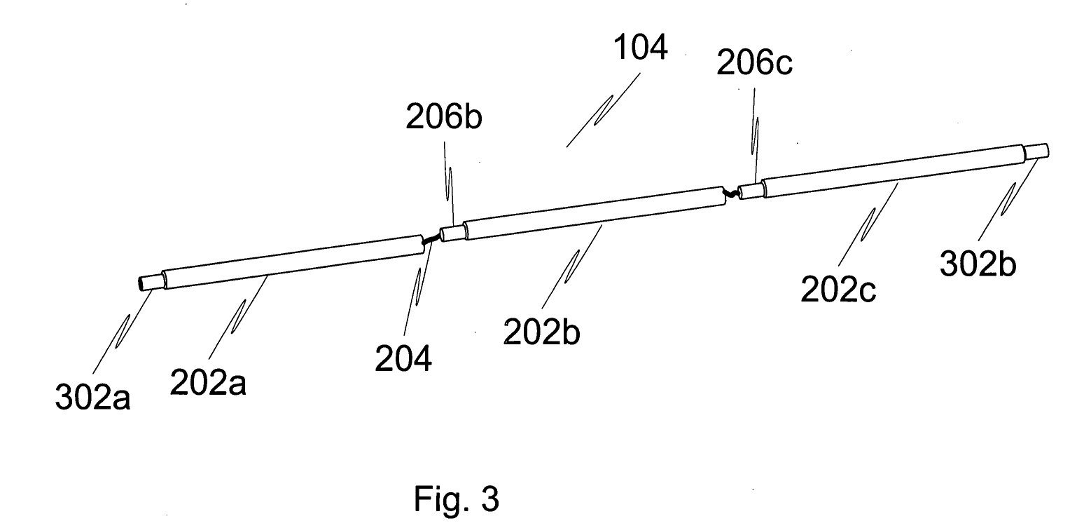

FIG. 3 is an illustration of a foldable tubing device, in accordance with an embodiment of the present invention. In an embodiment of the present invention, foldable tubing device 104 has end caps 302. End caps 302 are attached to one or both ends of foldable tubing device 104. End caps 302 are connected to flexible elastic material 204. In one embodiment of the present invention, flexible elastic material 204 is tied to end caps 302. It will be apparent to one skilled in the art that the means of connecting elastic material 204 to end caps 302 does not limit the scope of the invention and there are other means of connecting elastic material 204 to end caps 302 that are within the scope of the invention. In one embodiment of the present invention, end caps 302 help foldable tubing device 104 to releasably attach to one or more recesses in an automobile cargo area. In another embodiment of the present invention, end caps 302 help foldable tubing device 104 to releasably attach to one or more recesses in an automobile cargo area such that foldable automobile security screen 100 is held in a substantially horizontal position. In yet another embodiment of the present invention, end caps 302 help foldable tubing device 104 to releasably attach to one or more recesses in an automobile cargo area such that foldable automobile security screen 100 is held in a substantially vertical position.

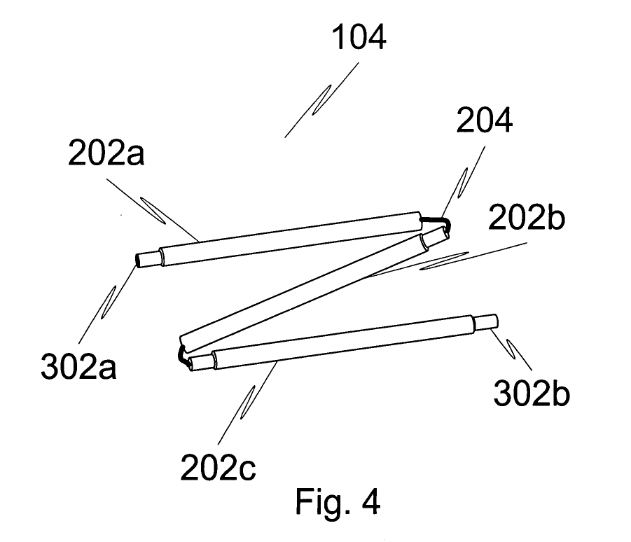

FIG. 4 is an illustration of a foldable tubing device, in accordance with an embodiment of the present invention. Foldable tubing device 104 is shown in a folded position. There are several other configurations in which foldable tubing device 104 can be folded. These are not shown here for the sake of conciseness. It will be apparent to one skilled in the art that other folded configurations are within the scope of this invention. Also, for the sake of simplicity of the drawings, screen 102 is omitted from FIG. 4. It will be apparent to one skilled in the art that foldable tubing device 104 will be attached to screen 102 in the folded position as shown in FIG. 4.

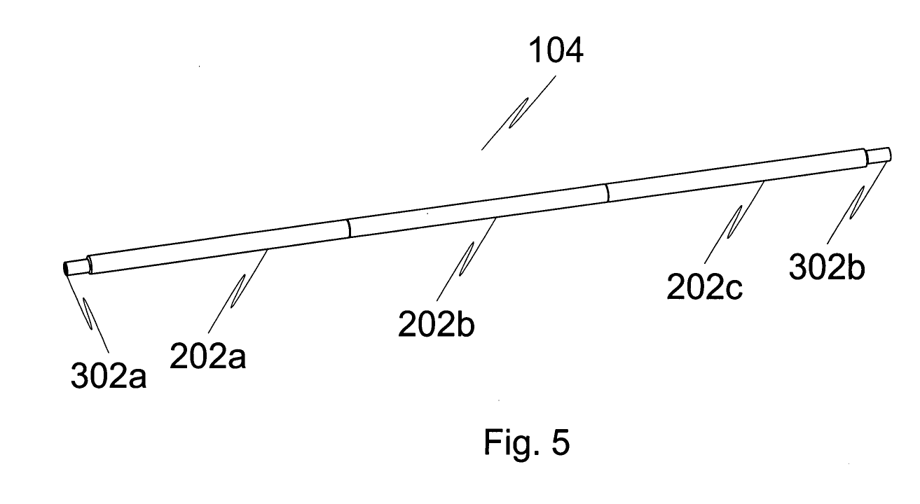

FIG. 5 is an illustration of a foldable tubing device in a rigid position, in accordance with an embodiment of the present invention. In this figure, lengths 206 (not shown) are inserted into bars 202. This makes tubing device 104 rigid. Screen 102 has been omitted from the drawing for the sake of simplicity but tubing device 104 is attached to screen 102 in this position.

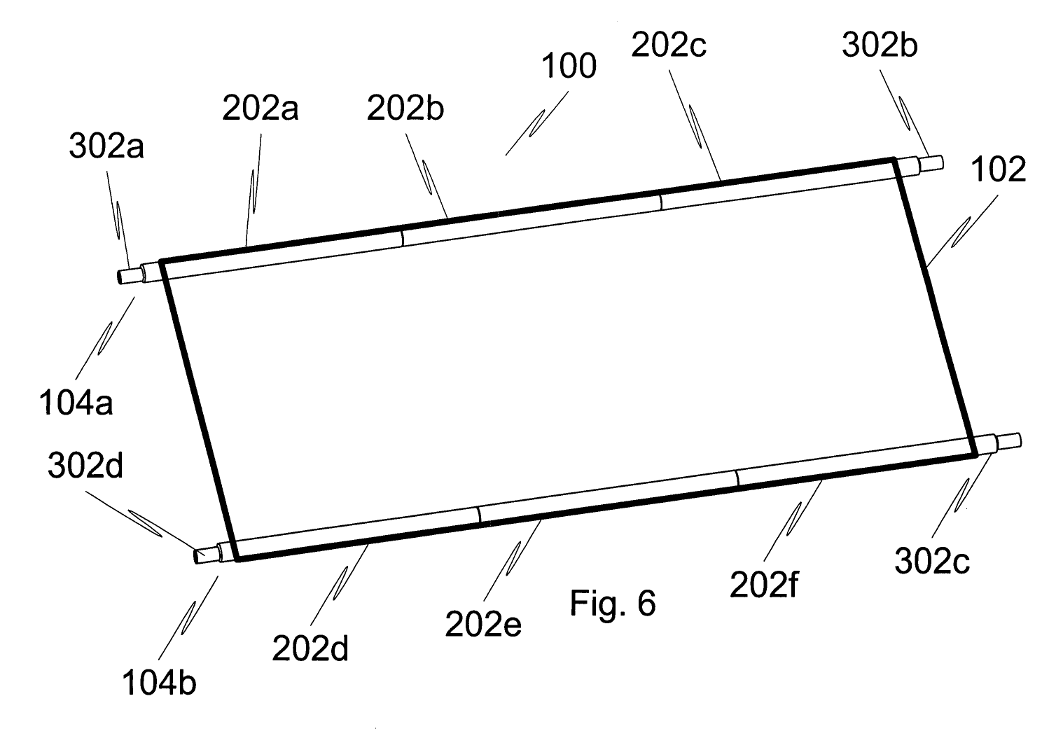

FIG. 6 is an illustration of a foldable automobile cargo security screen, in accordance with an embodiment of the present invention. Foldable automobile cargo security screen comprises of a foldable screen 102 and two foldable tubing devices 104a and 104b. Tubing devices 104a and 104b each comprise three bars, 202a-202c and 202d-202f, respectively. Tubing device 104a has end caps 302a and 302b attached to both of its ends and has flexible elastic material 204a (not shown) running through its center. Flexible elastic material 204a (not shown) is connected to end caps 302a and 302b. Tubing device 104b has end caps 302c and 302d attached to both of its ends and has flexible elastic material 204b (not shown) running through its center. Flexible elastic material 204b (not shown) is connected to end caps 302c and 302d. As shown in FIG. 5, foldable tubing devices 104 are in the rigid position. Screen 102 is extended to its full length over foldable tubing devices 104.

Certain modifications and improvements will occur to those skilled in the art upon a reading of the detailed description. All modifications and improvements have been deleted herein for the sake of conciseness and readability but are properly within the scope of the following claims.

1. A foldable security screen, comprising:
a) a screen; and
b) at least one foldable tubing device, the at least one foldable tubing device comprising a plurality of bars, wherein each bar is flexibly attached to at least one other bar, wherein the at least one foldable tubing device is connected to the screen; and wherein one of the bars forming part of the at least one foldable tuning device is releasably interlocked with at least one other bar to form a rigid tubing device.

2. (canceled)

3. The foldable security screen of claim 1, wherein one of the bars forming part of the at least one tubing device is capable of forming an angle in the range from about 0 to about 180 degrees with the at least one other bar.

4. The foldable security screen of claim 1, wherein the screen is quadrilateral in shape.

5. The foldable security screen of claim 1, wherein the screen is made from cloth or a cloth derivative.

6. The foldable security screen of claim 1, wherein the screen is made from any foldable material.

7. The foldable security screen of claim 1, wherein the screen has multiple edges and one of the at least one foldable tubing device is attached to at least one edge of the screen.

8. The foldable security screen of claim 7, wherein the screen is securely wrapped around the at least one tubing device to attach the at least one tubing device to the screen.

9. The foldable security screen of claim 7, further comprising a second foldable tubing device wherein the second foldable tubing device is attached to another edge of the screen.

10. The foldable security screen of claim 7, wherein the foldable tubing device further comprises at least one extending device attached to at least one edge of the at least one tubing device.

11. The foldable security screen of claim 10, wherein the length of the at least one tubing device is greater than the length of the edge of the screen to which the tubing device is attached forming an excess length of the tubing device.

12. The foldable security screen of claim 11, wherein the excess length of the tubing device releasably attaches to one or more recesses in an automobile to hold the foldable security screen in a substantially horizontal orientation.

13. The foldable security screen of claim 11, wherein the excess length of the tubing device releasably attaches to one or more recesses in an automobile to hold the foldable security screen in a substantially vertical orientation.

14. The foldable security screen of claim 11, wherein the excess length of the tubing device releasably attaches to one or more recesses in an automobile to hold the foldable security screen in a substantially inclined orientation.

15. The foldable security screen of claim 10, wherein the at least one extending device comprises a cap attached to at least one end of the tubing device.

16. The foldable security screen of claim 1, wherein at least two of the bars forming part of the at least one tubing device are connected be means of an elastic material.

17. The foldable security screen of claim 16, wherein at least one of the bars has a hollow core.

18. The foldable security screen of claim 17, wherein the elastic material runs through the hollow core of at least one of the bars.

19. A foldable security screen, comprising:
a) a screen comprising multiple edges; and
b) at least one foldable tubing device attached to at least one edge of the screen, wherein each tubing device comprises a plurality of bars, each bar being flexibly attached by means of an elastic material to at least one other bar such that the plurality of bars can be releasably interlocked to form a rigid structure: wherein the foldable tubing device comprises at least one extending device attached to at least one edge of the at least one tubing device: wherein the length of the at least one tubing device is greater than the length of the edge of the screen to which the tubing device is attached forming an excess length of the tubing device; and wherein the excess length of the tubing device releasably attaches to one or more recesses in an automobile.

20. The foldable security screen of claim 19, wherein one of the bars forming part of the at least one tubing device is capable of forming an angle in the range from about 0 to about 180 degrees with the at least one other bar.

21. A foldable security screen, comprising:
a) an opaque, lightweight screen for visually concealing objects underneath it comprising multiple edges;. and
b) at least one foldable tubing device, the at least one foldable tubing device comprising a plurality of bars having a hollow core, wherein each bar is flexibly attached to at least one other bar by means of an elastic material running through the hollow core such that the plurality of bars can be releasably interlocked to form a rigid structure without an additional joint device, wherein one of the bars forming part of the least one tubing device is capable of forming an angle in the range from about 0 to about 180 degrees with the at least one other bar, wherein the screen is securely wrapped around the at least one tubing device to attached the at least one tubing device;
c) at least one extending device attached to at least one edge of the at least one tubing device, wherein the length of the at least one tubing device is greater than the length of the edge of the screen to which the tubing device is attached forming an excess length of the tubing device, wherein the excess length of the tubing device is releasably attached to one or more recesses in an automobile to hold the security screen in multiple orientations.
